(19) United States
(12) Patent Application Publication
(10) Pub. No.: US 2013/0195016 A1
(43) Pub. Date: Aug. 1, 2013

(54) METHOD AND APPARATUS OF COMMUNICATING MACHINE TYPE COMMUNICATION DATA OVER AN IU INTERFACE IN A UNIVERSAL MOBILE TELECOMMUNICATIONS SYSTEM

(71) Applicants: Satish Nanjunda Swamy Jamadagni, Bangalore (IN); Sarvesha Anegundi Ganapathi, Bangalore (IN); Pradeep Krishnamurthy Hirisave, Bangalore (IN)

(72) Inventors: Satish Nanjunda Swamy Jamadagni, Bangalore (IN); Sarvesha Anegundi Ganapathi, Bangalore (IN); Pradeep Krishnamurthy Hirisave, Bangalore (IN)

(73) Assignee: Samsung Electronics Co., Ltd., Suwon-si, Gyeonggi-do (KR)

(21) Appl. No.: 13/878,857

(22) PCT Filed: Oct. 12, 2011
(86) PCT No.: PCT/KR11/07597

§ 371 Date: Apr. 11, 2013

(30) Foreign Application Priority Data
Oct. 12, 2010 (IN) 3026/CHE/2010

(51) Int. Cl. H04L 29/08

(52) U.S. Cl. CPC H04L 29/08765
USPC 370/328

(57) ABSTRACT

A method and an apparatus for communicating Machine Type Communication (MTC) data across an Iu interface in a Universal Mobile Telecommunications System (UMTS) network environment are provided. The apparatus includes Packet Data Units (PDUs) associated with one or more MTC devices are aggregated by a radio network controller. The aggregated PDUs associated with the one or more MTC devices are concatenated into an Iu PDU based on a Radio Access Bearer (RAB) identifier associated with the one or more MTC devices. The Iu PDU including the aggregated PDUs is transmitted to a core network across an Iu-Packet Switched (PS) interface that connects the radio network controller and the core network.

### PRIORITY

This application is a National Stage application under 35 U.S.C. §371 of an International application filed on Oct. 12, 2011 and assigned application No. PCT/KR2011/007597, and claims the benefit under 35 U.S.C. §365(b) of an Indian patent application filed on Oct. 12, 2010 in the Indian Intellectual Property Office and assigned Serial No. 3026/CHE/2010, the entire disclosure of which is hereby incorporated by reference.

### BACKGROUND OF THE INVENTION

1. Field of the Invention

The present invention relates to the field of Universal Mobile Telecommunications System (UMTS). More particularly, the present invention relates to communicating machine type communication data over an Iu interface in a Universal Mobile Telecommunications System.

2. Description of the Related Art

UMTS is a third generation mobile cellular technology based on the Global System for a Mobile communications (GSM) standard. UMTS is roughly divided into a user equipment, a Universal Terrestrial Radio Access Network (UTRAN), and a core network. A UTRAN is a communication network (commonly referred to as 3^{rd} Generation (3G)) which allows connectivity between the user equipment and the core network for providing a Circuit Switched (CS) service and a Packet Switched (PS) service. For example, a general voice conversation service is a circuit switched service, while a smart metering service via an Internet Protocol connection is classified as a PS service.

Typically, the UTRAN includes one or more Radio Network Sub-systems (RNSs). Each RNS includes a Radio Network Controller (RNC) and one or more Node Bs managed by the RNC. Each RNC typically assigns and manages radio resources, and operates as an access point with respect to the core network. The one or more Node Bs receive information sent by the user equipment through an uplink and transmit data to the respective user equipment through downlink. In other words, the Node Bs acts as access points of the UTRAN for the user equipment.

The core network includes a Mobile Switching Center (MSC) and a Gateway Mobile Switching Center (GMSC) connected together for supporting a CS service. The core network also includes a Serving General Packet Radio Service (GPRS) Support Node (SGSN) and a gateway GPRS support node connected together for supporting a PS services.

For supporting circuit switched services, the RNCs are connected to the MSC of the core network and the MSC is connected to the GMSC that manages the connection with other networks. For supporting packet switched services, the RNCs are connected to the SGSN and the GMSC of the core network. The SGSN supports packet communications with the RNCs and the GMSC manages the connection with other packet switched networks, such as the Internet.

Various types of interfaces exist between network components to allow the network components to transmit and receive information with each other. An interface between the RNC and the core network is defined as an Iu interface. More particularly, the Iu interface between the RNCs and the core network for packet switched systems is defined as “Iu-PS” and the Iu interface between the RNCs and the core network for circuit switched systems is defined as “Iu-CS”.

The user equipment availing CS/PS services from the core network via the UTRAN includes legacy devices or non-legacy devices, such as Machine to Machine communication (M2M) devices. Legacy devices are devices which access CS and PS services, such as mobile phones. M2M communication (also referred to as a “Machine-Type Communication” or “MTC”) is a form of data communication between devices that do not necessarily need human interaction (commonly known as MTC devices) unlike legacy devices.

For example, in an M2M communication, an MTC device (such as a sensor, a smart-meter, or the like) may capture an event data which is relayed through a Node B as PS data to an application residing in the core network via an ‘Iu-PS’ interface for analysis and necessary action. M2M communication may be used in a variety of areas, such as smart metering systems (e.g., in applications related to power, gas, water, heating, grid control, and industrial metering), surveillance systems, order management, gaming machines, and health care communication. Additionally, M2M communication based on MTC technology may be used in areas, such as customer service.

Currently, a large number of MTC devices are being deployed in a UMTS for availing PS services from the core network. For example, in New York City/Washington DC, approximately 15000 smart meters having machine to machine communications enabled are being installed per Node B for supporting smart grid application. Therefore, a large number of M2M data (e.g., M2M calls) is expected to be exchanged between the RNCs and the core network across the Iu-PS interface. However, the M2M data exchanged between the core network and the MTC devices over the UTRAN is small sized data (e.g., around 20KB). Thus, large number of low sized data communicated between the UTRAN and the core network across the Iu-PS interface may result in overloading the Iu-PS interface, thereby affecting throughput of the UMTS.

Therefore, a need exists to communicate machine type communication data over an Iu interface in a universal mobile telecommunications system without overloading the Iu-PS interface.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to communicate machine type communication data over an Iu interface in a universal mobile telecommunications system.

In accordance with an aspect of the present invention, a method of communicating Machine Type Communication (MTC) data across an Iu interface in a Universal Mobile Telecommunication System (UMTS) is provided. The method includes aggregating Packet Data Units (PDUs) associated with one or more MTC devices in a UMTS network environment, concatenating the aggregated PDUs associated with the one or more MTC devices into an Iu PDU, and multiplexing the Iu PDU including the concatenated PDUs across an Iu-PS interface connecting a radio network controller and a core network.

In accordance with another aspect of the present invention, an apparatus comprising a processor, and a memory coupled to the processor is provided. The memory includes a PDU concatenation module configured for aggregating PDUs associated with one or more MTC devices in a UMTS network environment, concatenating the aggregated PDUs associated with the one or more MTC devices into an Iu PDU, and multiplexing the Iu PDU including the concatenated PDUs across an Iu-PS interface.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a block diagram of a Universal Mobile Telecommunications System (UMTS) for communicating Machine Type Communication (MTC) data across an Iu-PS interface according to an exemplary embodiment of the present invention.

FIG. 2 is a process flow diagram illustrating a method of establishing a Radio Access Bearer (RAB) between an MTC device and a Radio Network Controller (RNC) according to an exemplary embodiment of the present invention.

FIG. 3 is a process flow diagram illustrating a method of communicating MTC data over an Iu-PS interface according to an exemplary embodiment of the present invention.

FIG. 4 is a schematic representation of an initialization control frame according to an exemplary embodiment of the present invention.

FIG. 5 illustrates a block diagram of an RNC according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

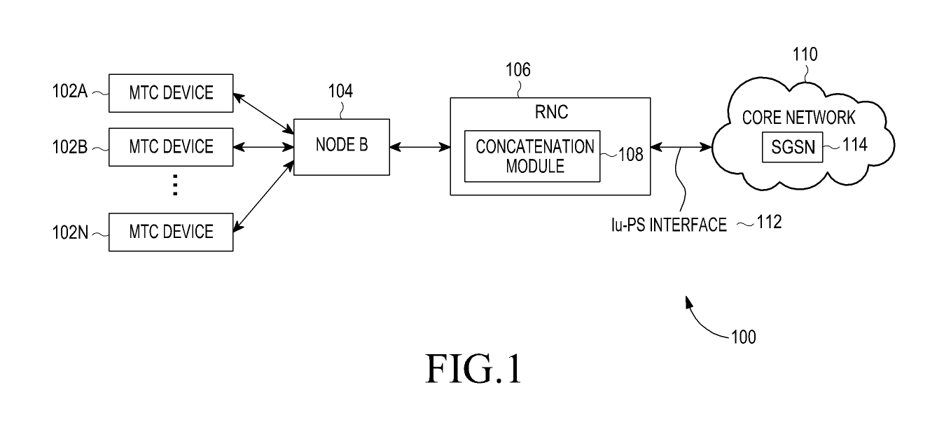

FIG. 1 illustrates a block diagram of a Universal Mobile Telecommunications System (UMTS) for communicating Machine Type Communication (MTC) data across an Iu-Packet Switched (PS) interface according to an exemplary embodiment of the present invention.

Referring to FIG. 1, a UMTS 100 includes MTC devices 102A-N, a Node B 104, a Radio Network Controller (RNC) 106, and a core network 110. The MTC devices 102A-N and the Node B 104 are connected via a wireless link (not shown). The RNC 106 and the core network 110 are connected via an Iu-PS interface 112. It is appreciated that, the Node B and the RNC 106 are part of a Universal Terrestrial Radio Access Network (UTRAN). For the purpose of illustration, only one Node B is illustrated as part of the UMTS 100. However, one skilled in the art can realize that there can be more than one Node Bs in the UMTS 100. In addition, each of the Node Bs is configured for supporting MTC devices and/or legacy devices. The RNC 106 includes a Packet Data Unit (PDU) concatenation module 108 operable for efficiently communicating MTC data across the Iu-PS interface 112, according to an exemplary embodiment of the present invention.

In an exemplary implementation, the RNC 106 receives one or more PDUs containing PS data from the MTC devices 102A-N (e.g., sensors or smart-meters) via the Node B 104. For example, the MTC devices 102A-N may capture an event data associated with an event and relay the event data to the RNC 106 for communicating with an application residing in the core network 110.

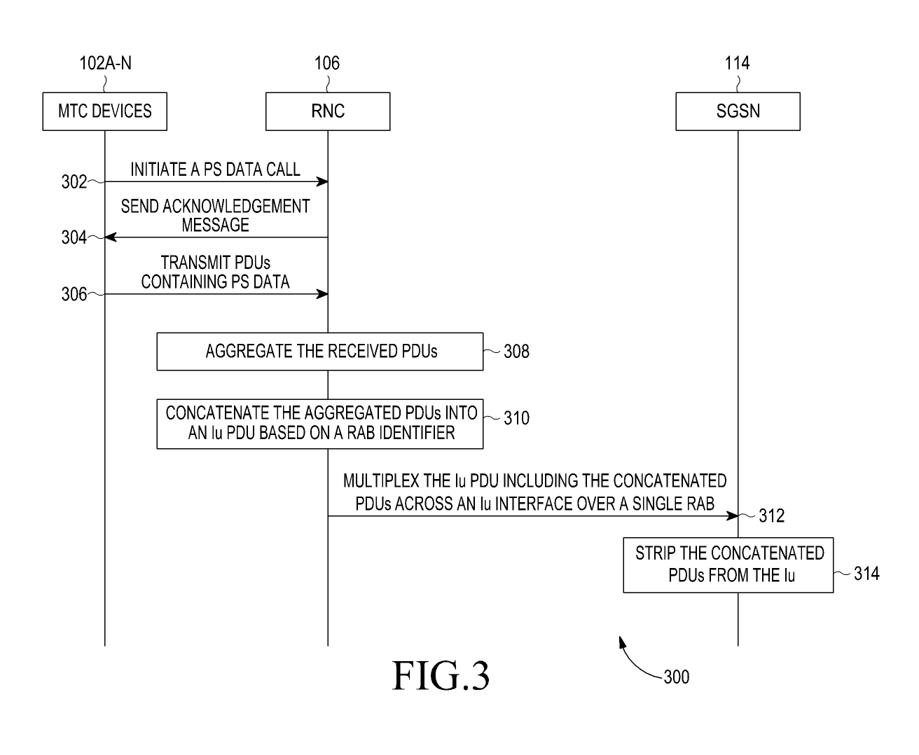

In an exemplary operation, the PDU concatenation module 108 stores the PDUs received from the MTC devices 102A-N for a period of time. In some exemplary embodiments, a core network element (e.g., a Serving General Packet Radio Service (GPRS) Support Node (SGSN)) 114 may instruct the PDU concatenation module 108 to store the PDUs associated with the MTC device 102A or the group of MTC devices 102A-N based on a predefined criterion. The predefined criterion may be based on a group identifier associated with the MTC devices 102A-N, a Radio Access Bearer (RAB) identifier, an overload condition of the Iu-PS interface 112, time period, priority of the aggregated PDUs, and the like. In these exemplary embodiments, the PDU concatenation module 108 aggregates the received PDUs based on the instructions and concatenates the aggregated PDUs received from the MTC devices 102A-N in an Iu PDU. Accordingly, the PDU concatenation module 108 multiplexes the Iu PDU including the concatenated PDUs to the SGSN 114 over the Iu-PS interface 112. The process steps performed by the PDU concatenation module 108 in uplink are described with reference to FIG. 3.

Although, FIG. 1 illustrates that the PDU concatenation module 108 resides in the RNC 106, one can envision that the core network 110 can also have the PDU concatenation module 108. For example, when the PDU concatenation module 108 resides in the SGSN 114, the PDU concatenation module 108 may concatenate PDUs intended for one or more MTC devices 102A-N in an Iu PDU and multiplexes the Iu PDU containing the concatenated PDUs to the RNC 106 over the Iu-PS interface 112. In one exemplary embodiment, the PDU concatenation module 108 concatenates the aggregated PDUs and multiplexes the concatenated PDUs across the Iu interface based on an overload indication associated with the Iu-PS interface 112.

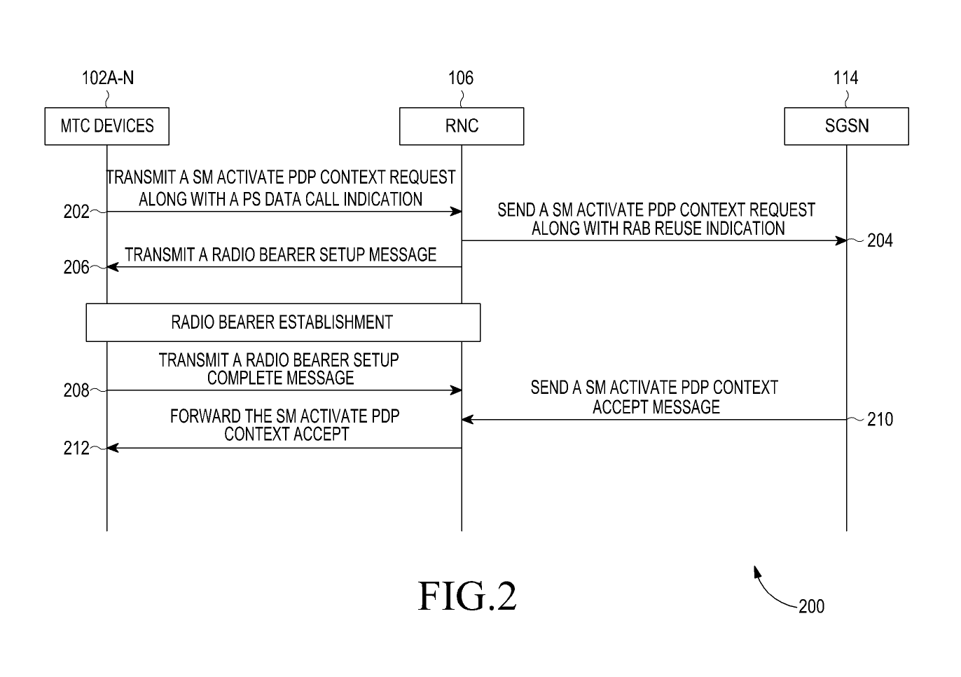

FIG. 2 is a process flow diagram illustrating a method of establishing an RAB between an MTC device and an RNC according to an exemplary embodiment of the present invention.

Referring to FIG. 2, at step 202 of process flow diagram 200, an MTC device 102A transmits a Session Management (SM) activate Packet Data Protocol (PDP) context request along with a PS data call indication to the RNC 106 via the Node B 104. For example, the SM activate PDP context request is transmitted in a Radio Resource Connection (RRC) direct transfer message. In one exemplary embodiment, the PS data call indication may enable the PDU concatenation module 108 to aggregate PDUs received from the MTC device 102A or the group of MTC devices 102A-N and reuse the existing RAB for multiplexing the aggregated PDUs across the Iu-PS interface 112. In such case, the MTC devices 102A-N are grouped together and assigned an RAB identifier associated with the existing RAB for concatenating the aggregated PDUs based on the RAB identifier. In one exemplary embodiment, a unique Radio Frequency Conducted Interference (RFCI) and associated subflows corresponding to the RAB identifier are allocated to each of the MTC devices 102A-N in such a way that multiple RFCIs represent multiples MTC devices in the same RAB. In another exemplary embodiment, multiple subflows across RFCIs corresponding to the RAB identifier are allocated to each of the MTC devices 102A-N.

At step 204, the RNC 106 relays the SM activate PDP context request along a RAB reuse indication in a Radio Access Network Application Part (RANAP) direct transfer message to the SGSN 114. At step 206, the RNC 106 sends a radio bearer setup message to the MTC device 102A. At step 208, the MTC device 102A sends a radio bearer complete message to the RNC 106 upon successful radio bearer establishment. At step 210, the SGSN 114 sends an SM activate PDP context accept message to the RNC 106 without performing a Iu-PS bearer establishment procedure. At step 212, the RNC 106 forwards the SM activate PDP context accept message to the MTC device 102A.

FIG. 3 is a process flow diagram illustrating a method of communicating MTC data over an Iu-PS interface according to an exemplary embodiment of the present invention.

Referring to FIG. 3, at step 302 of process flow diagram 300, one of the MTC devices 102A-N initiates a PS data call with the RNC 106 via the Node B 104. The PS data call may be initiated by sending a service request message to the RNC 106. The service request message may indicate that the MTC devices 102A-N intend to communicate PS data with the core network 110 during the PS data call. Alternatively, the RNC 106 may determine that the call is from the MTC device 102A through a Random Access CHannel (RACH) call cause or Radio Link Control (RLC)/Medium Access Control (MAC) indication.

At step 304, the RNC 106 sends an acknowledgement message in response to initiation of the PS data call. At step 306, each of the MTC devices 102A-N transmits PDU(s) containing PS data to the RNC 106. At step 308, the RNC 106 aggregates the PDUs received from the MTC devices 102A-N for a predefined time period. The predefined time period may be communicated by one of the MTC devices 102A-N in response to the acknowledgment message or determined by the RNC 106.

At step 310, the RNC 106 concatenates the aggregated PDUs into an Iu PDU based on a RAB identifier assigned to the MTC devices 102A-N during the radio bearer establishment. At step 312, the RNC 106 multiplexes the Iu PDU containing the concatenated PDUs to the SGSN 114 across the Iu-PS interface 112 over an single RAB associated with the assigned RAB identifier. At step 314, the SGSN 114 stripes the concatenated PDUs in the Iu PDU for further processing the PS data.

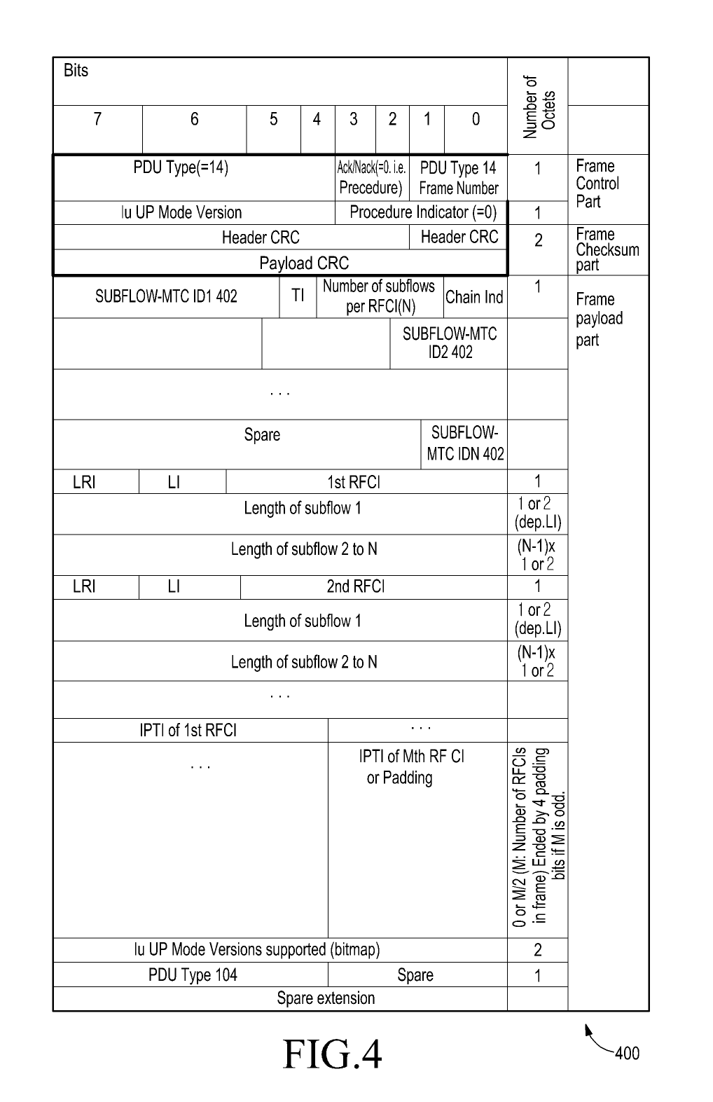

FIG. 4 is a schematic representation of an initialization control frame according to an exemplary embodiment of the present invention.

Referring to FIG. 4, a control frame 400 includes a subflow identifier field 402, and a PDU type field 404. The subflow identifier field 402 includes subflow identifiers associated with subflow allocated to each of the MTC devices 102A-N. The subflow identifier field 402 indicates mapping between RFCIs and subflows allocated to different MTC devices 104A-N within a single RAB. The PDU type field 404 indicates whether the PDUs are concatenated into an Iu PDU.

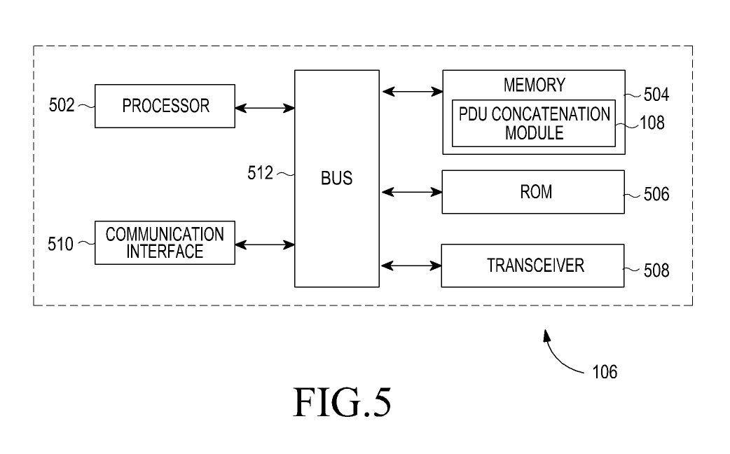

FIG. 5 illustrates a block diagram of an RNC according to an exemplary embodiment of the present invention.

Referring to FIG. 5, the RNC 106 includes a processor 502, a memory 504, a Read Only Memory (ROM) 506, a transceiver 508, a communication interface 510, and a bus 512.

The processor 502, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

The memory 504 may be any one of a volatile memory and a non-volatile memory. The memory 504 includes the PDU concatenation module 108 for aggregating PDUs received from the one or more MTC devices 102A-N and concatenating the aggregated PDUs into a single Iu PDU. A variety of computer-readable storage media may be stored in and accessed from the memory elements. Memory elements may include any suitable memory device(s) for storing data and machine-readable instructions, such as a read only memory, a random access memory, an erasable programmable read only memory, an electrically erasable programmable read only memory, a hard drive, a removable media drive for handling memory cards, Memory Sticks™, and the like.

Exemplary embodiments of the present invention may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 502. For example, a computer program may include machine-readable instructions capable of aggregating PDUs received from one or more MTC devices 102A-N and concatenating the aggregated PDUs into a single Iu PDU. In one exemplary embodiment, the computer program may be included on a storage medium and loaded from the storage medium to a hard drive in the non-volatile memory. The transceiver 508 is configured for multiplexing the Iu PDU including the concatenated PDUs across the Iu interface 112 over a single RAB.

In various exemplary embodiments, the method and apparatus described in FIGS. 1-4 enable communication of MTC data across the Iu-PS interface both in uplink (the RNC 106 to the SGSN 114) and downlink (the SGSN 114 to the RNC 106) directions. Furthermore, PDUs received from one or more MTC devices 102A-N are concatenated into an Iu PDU prior to multiplexing across the Iu-PS interface 112 based on an overload indication associated with the Iu-PS interface 112. For example, the SGSN 114 can send an overload indication to the RNC 106 for initializing concatenation of PDUs. Alternatively, the RNC 106 can send an overload indication to the SGSN 114 suggesting a need to concatenate PDUs in an Iu PDU. One skilled in the art will realize that the PDUs that are concatenated are associated with a single MTC device or multiple MTC devices belonging to a group of MTC devices.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method of communicating Machine Type Communication (MTC) data across an Iu interface in Universal Mobile Telecommunication System (UMTS), the method comprising:
aggregating Packet Data Units (PDUs) associated with one or more MTC devices in a UMTS network environment;
concatenating the aggregated PDUs associated with the one or more MTC devices into an Iu PDU; and
multiplexing the Iu PDU including the concatenated PDUs across an Iu-Packet Switched (PS) interface connecting a radio network controller and a core network.

2. The method of claim 1, further comprising:
notifying a core network element that PDUs associated with the one or more MTC devices are to be aggregated.

3. The method of claim 1, wherein the aggregating of the PDUs associated with the one or more MTC devices in the UMTS network environment comprises:
receiving a notification from a core network element indicating that the Iu-PS interface connecting the radio network controller and the core network is overloaded; and
aggregating PDUs received from the one or more MTC devices by the radio network controller based on the notification.

4. The method of claim 1, wherein the aggregating of the PDUs associated with the one or more MTC devices in the UMTS network environment comprises:
determining an overload condition associated with an Iu-PS interface connecting the radio network controller and the core network; and
aggregating PDUs associated with the one or more MTC devices by a core network element based on the determination.

5. The method of claim 1, further comprising:
assigning a Radio Access Bearer (RAB) identifier to the one or more MTC devices.

6. The method of claim 5, wherein the assigning of the RAB identifier to the one or more MTC devices comprises:
allocating a unique Radio Frequency Conducted Interference (RFCI) and associated subflows that corresponds to the RAB identifier to each of the one or more MTC devices.

7. The method of claim 5, wherein the assigning of the RAB identifier to the one or more MTC devices comprises:
allocating multiple subflows across RFCIs corresponding to the RAB identifier to each of the one or more MTC devices.

8. The method of claim 5, wherein the concatenating of the aggregated PDUs associated with the one or more MTC devices into the Iu PDU comprises:
concatenating the aggregated PDUs associated with the one or more MTC devices into the Iu PDU based on the RAB identifier.

9. The method of claim 8, wherein the multiplexing of the Iu PDU including the concatenated PDUs across the Iu-PS interface comprises:
multiplexing the Iu PDU including the concatenated PDUs across the Iu-PS interface over an RAB associated with the RAB identifier.

10. An apparatus comprising:
a processor; and
a memory coupled to the processor, wherein the memory includes a Packet Data Unit (PDU) concatenation module configured for:
aggregating Packet Data Units (PDUs) associated with one or more Machine Type Communication (MTC) devices in a Universal Mobile Telecommunication System (UMTS) network environment;
concatenating the aggregated PDUs associated with the one or more MTC devices into an Iu PDU; and
multiplexing the Iu PDU including the concatenated PDUs across an Iu-Packet Switched (PS) interface.

11. The apparatus of claim 10, wherein the PDU concatenation module is configured for notifying a core network element that PDUs associated with the one or more MTC devices are to be aggregated.

12. The apparatus of claim 10, wherein the PDU concatenation module is configured for:
receiving a notification from a core network element indicating that the Iu-PS interface is overloaded; and
aggregating PDUs received from the one or more MTC devices based on the notification.

13. The apparatus of claim 10, wherein the PDU concatenation module is configured for:
determining an overload condition associated with an Iu-PS interface; and
aggregating PDUs associated with the one or more MTC devices based on the determination.

14. The apparatus of claim 10, wherein the PDU concatenation module is configured for assigning a Radio Access Bearer (RAB) identifier to the one or more MTC devices.

15. The apparatus of claim 14, wherein the PDU concatenation module is configured for allocating a unique Radio Frequency Conducted Interference (RFCI) and associated subflows that corresponds to the RAB identifier to each of the one or more MTC devices.

16. The apparatus of claim 14, wherein the PDU concatenation module is configured for allocating multiple subflows across RFCIs corresponding to the RAB identifier to each of the one or more MTC devices.

17. The apparatus of claim 14, wherein, in the concatenating of the aggregated PDUs associated with the one or more MTC devices into the Iu PDU, the PDU concatenation module concatenates the aggregated PDUs associated with the one or more MTC devices into the Iu PDU based on the RAB identifier.

18. The apparatus of claim 17, wherein, in the multiplexing of the Iu PDU including the concatenated PDUs across the Iu-PS interface, the PDU concatenation module multiplexing the Iu PDU including the concatenated PDUs across the Iu-PS interface over an RAB associated with the RAB identifier.
